(19) United States
(12) Patent Application Publication
(10) Pub. No.: US 2019/0135079 A1
(43) Pub. Date: May 9, 2019

(54) HEATING MEDIUM HEATING DEVICE AND VEHICLE AIR CONDITIONER USING SAME

(71) Applicant: MITSUBISHI HEAVY INDUSTRIES THERMAL SYSTEMS, LTD., Tokyo (JP)

(72) Inventor: Tomoyasu ADACHI, Aichi (JP)

(73) Assignee: Mitsuibishi Heavy Industries Thermal Systems, Ltd., Tokyo (JP)

(21) Appl. No.: 16/093,097

(22) PCT Filed: Oct. 20, 2016
(86) PCT No.: PCT/JP2016/081148

§ 371 Date: Oct. 11, 2018

(30) Foreign Application Priority Data
Jun. 10, 2016 (JP) 2016-116316

(51) Int. Cl. B60H 1/22; H05B 3/14; H05B 3/06; H05B 3/48; F24H 3/04

(52) U.S. Cl. CPC B60H 1/2225; H05B 3/14; H05B 3/06; B60H 2001/2268; F24H 3/0429; H05B 2203/02; H05B 3/48

(57) ABSTRACT

A heating medium heating device includes: a plate-shaped PTC heater formed by making compressive heat transfer sheets cover individually two surfaces of a PTC element; a first heating medium distribution box including a first matching surface in which a PTC heater accommodating recess is formed, the PTC heater accommodating recess including a bottom surface with which the compressive heat transfer sheet located on a first-surface side of the PTC heater is in close contact; a second heating medium distribution box including a flat second matching surface that closes the PTC heater accommodating recess by being bonded, liquid-tightly via a liquid gasket, to the first matching surface, the second matching surface being a surface with which the compressive heat transfer sheet located on a second-surface side of the PTC heater is in close contact; and a barrier part rising from a peripheral edge part of the PTC heater towards the second matching surface.

### TECHNICAL FIELD

The invention relates to a heating medium heating device configured to heat heating medium by means of a positive temperature coefficient (PTC) heater and to a vehicle air conditioner using the heating medium heating device.

### BACKGROUND ART

Hybrid vehicles have difficulty using the engine exhaust to heat the inside of the passenger compartment and electric-motor vehicles are equipped with no engines. A vehicle of such kinds is provided with a dedicated heating medium heating device configured to heat heating medium (engine cooling fluid, brine, or the like liquid) that is supplied to a heater core for warming air disposed in the passenger compartment. Use of a PTC heater as part of such a heating medium heating device is known, and some examples of such use are disclosed in Patent Documents 1 to 3. A PTC heater employs a positive temperature coefficient thermistor element (a.k.a. PTC element) as a heat generating element, and a PTC element may be formed in a thin, plate shape, which allows the heating medium heating device to be formed in a thin and compact device.

Each of the heating medium heating devices disclosed in Patent Documents 1 to 3 includes: a first heating medium distribution box including a heating medium circulation path formed inside of the first heating medium distribution box; a second heating medium distribution box including a heating medium circulation path formed inside of the second heating medium distribution box; and a plate-shaped PTC heater. The first and the second heating medium distribution boxes are adhered closely together with the PTC heater disposed between these boxes. The heating medium flows through both the heating medium circulation path of the first heating medium distribution box and the heating medium circulation path of the second heating medium distribution box. During that time, the heating medium is heated through heat exchange with the two surfaces of the PTC heater, and then flows through the heater core, in which the heat of the heating medium is provided to heat the passenger compartment.

A liquid gasket is applied to seal the interstice between the matching surface of the first heating medium distribution box and the matching surface of the second heating medium distribution box. This eliminates the need for a dedicated gasket member and thus reduces the manufacturing cost of the heating medium heating device. A widely used liquid gasket is a moisture curable one that is hardened by reacting with moisture in the air.

As illustrated in FIG. 5 of Patent Document 1 and in FIG. 4 and FIG. 5 of Patent Documents 2 and 3, a PTC heater accommodating chamber is formed between the first heating medium distribution box and the second heating medium distribution box, and the PTC heater accommodating chamber accommodates the PTC heater. The PTC heater has a configuration where an electrode plate and a compressive heat transfer sheet are layered in this order on each of the two surfaces of a flat PTC element.

An example of a suitable material for the compressive heat transfer sheet is a silicone sheet that has a good thermal conductivity and a good electrical insulation, and that in addition, is inexpensive. The PTC heater adheres to each of the first and the second heating medium distribution boxes via the corresponding one of the compressive heat transfer sheets. Hence, the heat of the PTC heater is conducted to the first and the second heating medium distribution boxes efficiently.

The PTC heater accommodating chamber is a sealed chamber formed by: forming a tray-shaped recessed portion in a matching surface of a first one of the first and the second heating medium distribution boxes; and liquid-tightly closing the recessed portion with a flat matching surface of a second one of the first and the second heating medium distribution boxes. As such, the recessed portion that will be used as the PTC heater accommodating chamber is formed only in one of the first and the second heating medium distribution boxes with reduced machining man-hours, and thus a higher productivity is achieved.

### CITATION LIST

### Patent Document

Patent Document 1: JP 4981386 B
Patent Document 2: JP 5535740 B
Patent Document 3: JP 5535742 B

### SUMMARY OF INVENTION

### Problems to be Solved by the Invention

As has been described above, the PTC heater is accommodated in the PTC heater accommodating chamber defined by closing the PTC heater accommodating recess formed in the matching surface of one of the heating medium distribution boxes with the flat matching surface of the other of the heating medium distribution boxes. In addition, the matching surfaces of the two heating medium distribution boxes are sealed with the liquid gasket. Hence, the liquid-gasket-coated surface (matching surface) and the compressive heat transfer sheet of one side of the PTC heater are positioned at the same level (height) and become contiguous in the surface direction without any level difference.

Hence, in a case where the liquid gasket applied to the matching surface of the heating medium distribution box bulges towards the PTC heater accommodating chamber, the liquid gasket may interfere with the compressive heat transfer sheet of the PTC heater. Alternatively, in a case where, on the other hand, the compressive heat transfer sheet becomes out of alignment in the surface direction, the compressive heat transfer sheet may interfere with the liquid gasket.

In both of the above-described cases, due to the adhering of the oil content (silicone oil) of the silicone material forming part of the silicone sheet to the liquid gasket or due to the covering of the liquid gasket with the compressive heat transfer sheet, it becomes harder for the liquid gasket to contact the air and thus the hardening of the moisture-curable liquid gasket is delayed, resulting in a lower productivity of the heating medium heating device.

A conceivable way of avoiding this problem is to widen the gap between the liquid-gasket-coated portion within the matching surface and the periphery of the PTC heater. This, however, requires the heating medium heating device to be as compact as possible even by a millimeter and results in widening of the external-diameter dimension of the heating medium heating device.

The invention has been made to solve this problem, and therefore provides a heating medium heating device usable in a vehicle air conditioner where a PTC heater accommodating chamber is formed between a plurality of heating medium distribution boxes whose matching surfaces are sealed by liquid gasket. In the vehicle air conditioner, the heating medium heating device suppresses the interference between the liquid gasket and compressive heat transfer sheets, each of which being layered on the corresponding one of the two surfaces of the PTC heater. The heating medium heating device prevents the hardening of the liquid gasket from being delayed, resulting in an improved productivity, and is made more compact. In addition, the invention also provides a vehicle air conditioner using the above-described heating medium heating device.

### Solution to Problems

To solve the above-described problems, the present invention provides the following means.

A heating medium heating device according to a first aspect of the invention includes: a plate-shaped PTC heater formed by making compressive heat transfer sheets cover individually two surfaces of a PTC element; a first heating medium distribution box including a first heating medium circulation path inside the first heating medium distribution box and a first matching surface in which a PTC heater accommodating recess is formed to accommodate the PTC heater, the PTC heater accommodating recess including a bottom surface with which the compressive heat transfer sheet located on a first-surface side of the PTC heater is in close contact; a second heating medium distribution box including a second heating medium circulation path inside the second heating medium distribution box and a flat second matching surface that closes the PTC heater accommodating recess by being bonded, liquid-tightly via a liquid gasket, to the first matching surface, the second matching surface being a surface with which the compressive heat transfer sheet located on a second-surface side of the PTC heater is in close contact; and a barrier part rising from a peripheral edge part of the PTC heater towards the second matching surface.

According to the heating medium heating device with the above-described configuration, even in the case where the liquid gasket applied to the interstice between the first matching surface and the second matching surface bulges towards the PTC heater accommodating recess, the bulging liquid gasket is blocked by the barrier part and thus does not interfere with the compressive heat transfer sheets of the PTC heater. In addition, the compressive heat transfer sheets, on the other hand, would not become out of alignment in the surface direction to the extent that the compressive heat transfer sheets would interfere with the liquid gasket. Hence, the delay of the hardening of the liquid gasket is prevented, resulting in an improved productivity of the heating medium heating device. In addition, by narrowing the gap between the liquid-gasket-coated portion within the matching surfaces and the periphery of the PTC heater, the heating medium heating device is made more compact.

In the heating medium heating device with the above-described configuration, a fitting groove allowing a leading end of the barrier part to be fitted in may be formed in the second matching surface. The fitting of the leading end of the barrier part in the fitting groove widens the distance between the compressive heat transfer sheets of the PTC heater and the liquid gasket bulging from the interstice between the first and the second matching surfaces. Hence the interference of the liquid gasket with the compressive heat transfer sheets is reliably prevented.

The barrier part may be made from a resin. Thus, the barrier part is formed inexpensively, and the barrier part interposed between the PTC heater and the first and the second heating medium distribution boxes made of a metal serves as an insulating member. Hence, the occurrence of an electrical short circuit between the PTC heater and the boxes is prevented.

The barrier part may be integrally formed with a frame member surrounding the PTC heater. Thus, the barrier part is provided without any significant increase in cost only by making a small change in the frame member provided in the PTC heater from the beginning.

In the heating medium heating device with the above-described configuration, a chamfered portion may be formed in a peripheral edge part surrounding the PTC heater accommodating recess within the first matching surface.

Thus, even in the case where the liquid gasket applied to the first and the second matching surfaces bulges towards the PTC heater accommodating recess, the bulging part is accumulated in the chamfered portion before the bulging part bulges towards the PTC heater accommodating recess. Hence, the bulging amount of the liquid gasket towards the PTC heater accommodating recess is decreased, and thus the interference between the liquid gasket and the compressive heat transfer sheets is prevented.

In addition, the formation of the chamfered portion allows a larger area of the liquid gasket to contact with the air. Thus, a shorter hardening time of the liquid gasket is achieved and thus a higher productivity is achieved.

A vehicle air conditioner according to a second aspect of the invention may include: a blower configured to circulate any of outside air and air in the passenger compartment; a cooler disposed on a downstream side of the blower; and a heater core disposed on a downstream side of the cooler, wherein the heating medium heated by the above-mentioned heating medium heating device is allowed to circulate in the heater core. The vehicle air conditioner achieves the advantageous effects described above.

### Advantageous Effect of Invention

As has been described thus far, according to the heating medium heating device of the invention and according to the vehicle air conditioner using the heating medium heating device, in the vehicle air conditioner where the PTC heater accommodating chamber is formed between the plurality of heating medium distribution boxes whose matching surfaces are sealed by the liquid gasket, the heating medium heating device suppresses the interference between the liquid gasket and the compressive heat transfer sheets each of which is layered on the corresponding one of the two surfaces of the PTC heater. The heating medium heating device prevents the hardening of the liquid gasket from being delayed, resulting in an improved productivity, and is made more compact.

### BRIEF DESCRIPTION OF DRAWINGS

FIG. 1 is a schematic configuration diagram of a vehicle air conditioner according to an embodiment of the present invention.

FIG. 2 is a perspective view of a heating medium heating device according to an embodiment of the present invention.

FIG. 3 is a front view of a heating medium heating device according to an embodiment of the present invention.

FIG. 4 is a plan view of the heating medium heating device seen from the direction indicated by the arrows IV-IV in FIG. 3.

FIG. 5 is a vertical cross-sectional view of the heating medium heating device taken along the line V-V in FIG. 4.

FIG. 6 is a horizontal cross-sectional view of the heating medium heating device taken along the line VI-VI in FIG. 5.

FIG. 7 is a vertical cross-sectional view of the heating medium heating device taken along the line VII-VII in FIG. 5.

FIG. 8 is a vertical cross-sectional view of the heating medium heating device taken along the line VIII-VIII in FIG. 4 and taken along the line VIII-VIII in FIG. 5.

FIG. 9 is a vertical cross-sectional view illustrating an embodiment of the invention by enlarging the IX portion of FIG. 5.

FIG. 10 is a perspective view illustrating a frame member of a PTC heater and a barrier part.

FIG. 11 is a perspective view illustrating a lower heating medium distribution box and a fitting groove.

### DESCRIPTION OF EMBODIMENTS

An embodiment of the present invention will now be described with reference to the drawings.

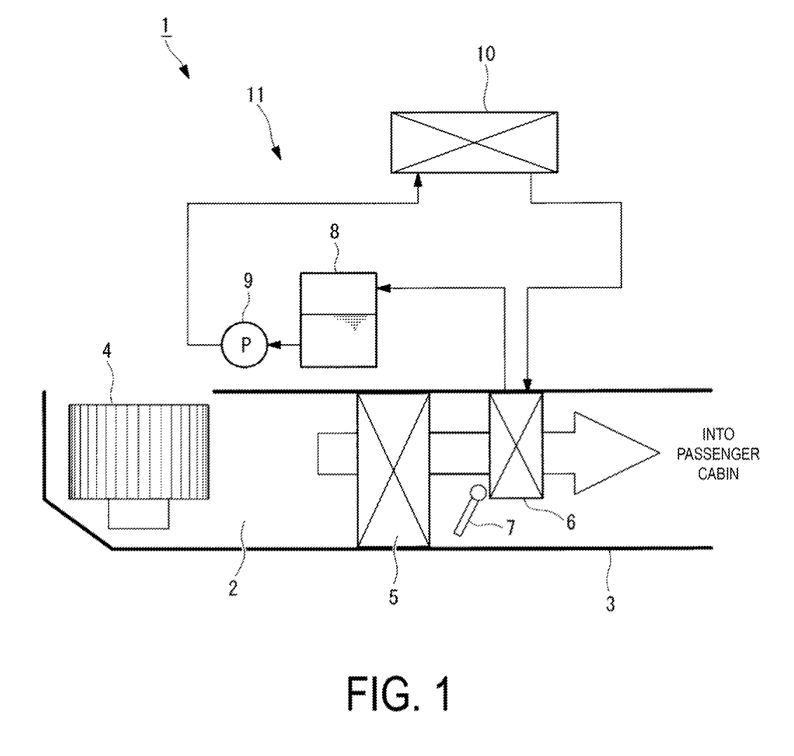

FIG. 1 is a schematic configuration diagram of a vehicle air conditioner according to the present embodiment. A vehicle air conditioner 1 is, for example, an air conditioner of a hybrid vehicle or of an electric-motor vehicle, and includes a casing 3. The casing 3 includes an air flow path 2 configured to take in the outside air or the air in the passenger compartment, adjust the temperature of the taken-in air, and then introduce the temperature-adjusted air into the passenger compartment.

In the casing 3, the following components are installed from the upstream side of the air flow path 2 to the downstream side thereof: a blower 4 configured to suck in the outside air or the air in the passenger compartment and to feed the sucked-in air to the downstream side; a cooler 5 configured to cool the air fed by the blower 4; a heater core 6 configured to heat the air cooled by the cooler 5 while the air is passing through the cooler 5; and an air mixing, damper 7 configured to adjust the amount of air passing through the heater core 6 and the amount of air bypassing the heater core 6, and thus adjust the temperature of the mixed air on the downstream side of the air mixing damper 7.

The downstream side of the casing 3 is connected, via an air-outlet mode switching damper and a duct (neither of which is illustrated), to a plurality of air outlet ports (not illustrated) configured to let the temperature-adjusted air out into the passenger compartment. The cooler 5, together with a compressor, a condenser, and an expansion valve (none of which is illustrated) form a refrigerant circuit. The cooler 5 cools the air passing therethrough by evaporating the refrigerant that has been expanded adiabatically by the expansion valve.

The heater core 6, together with a tank 8, a pump 9, and an engine (not illustrated) and the heating medium heating device 10 according to the invention, form a heating medium circulation circuit 11. An engine cooling fluid for hybrid vehicles is used as the heating medium flowing in the heating medium circulation circuit 11. For electric-motor vehicles, equipped with no engines, employ brine for the same purpose. The heating medium circulation circuit 11 is configured to make the heating medium heating device 10 heat the heating medium (i.e., the engine cooling fluid) whose temperature is not raised enough (e.g., while the vehicle is running in the hybrid driving mode), then to make the pump 9 to circulate the heated engine cooling fluid in the heating medium circulation circuit 11, and thus to heat the air passing through the heater core 6 in the casing 3.

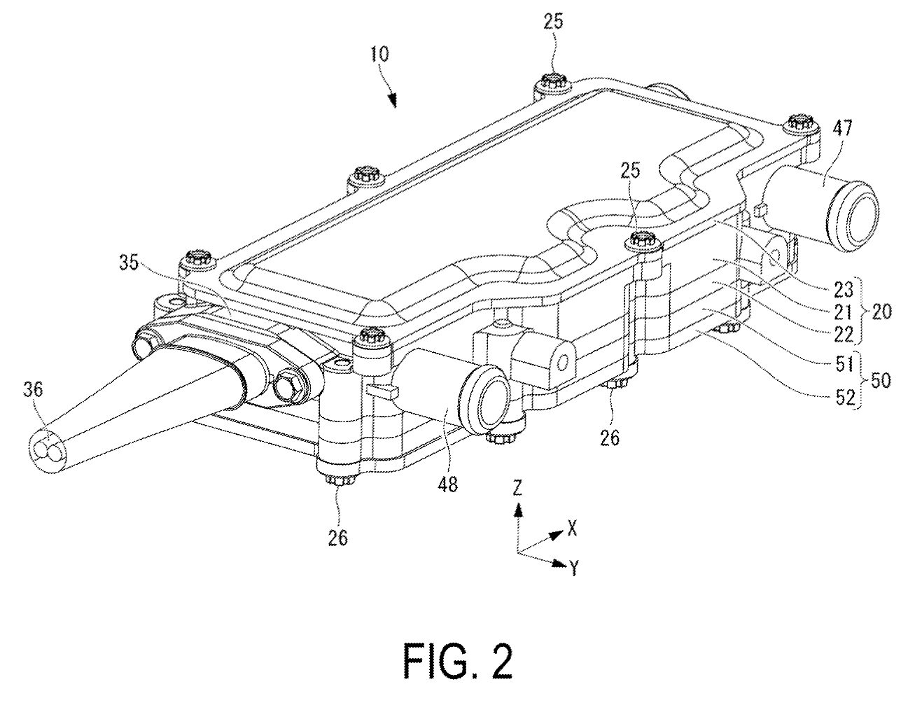

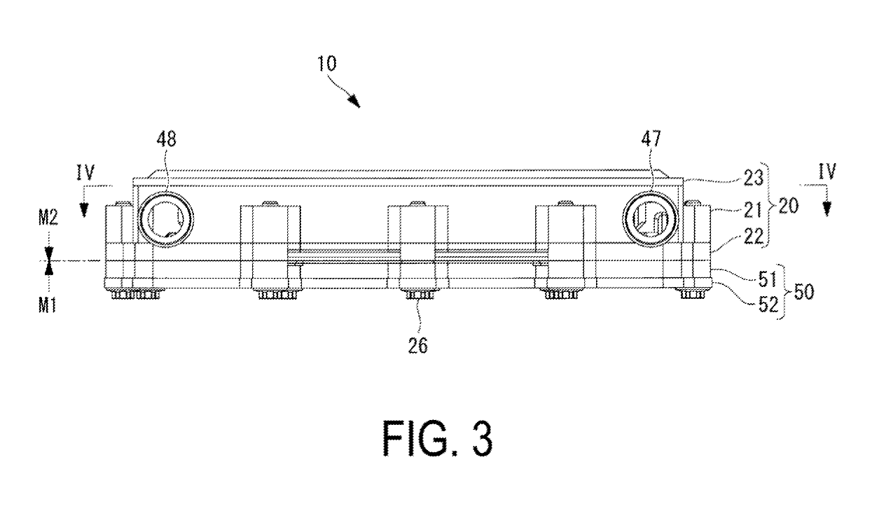

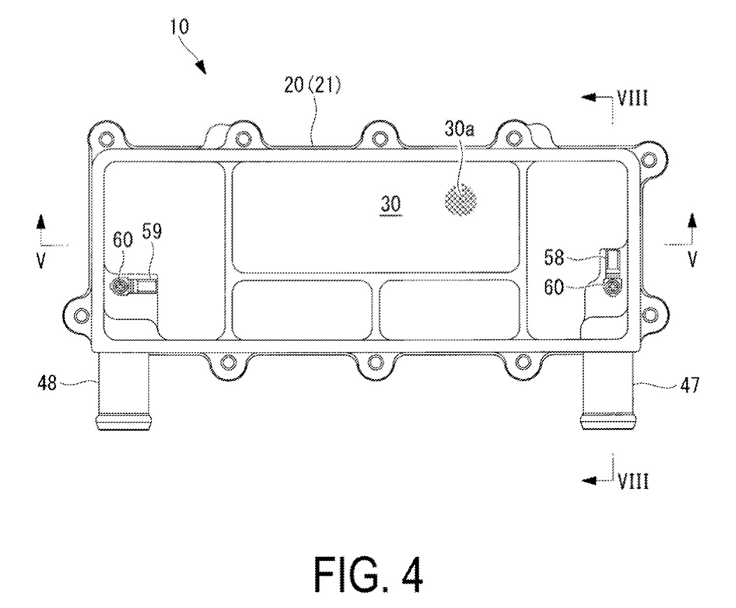

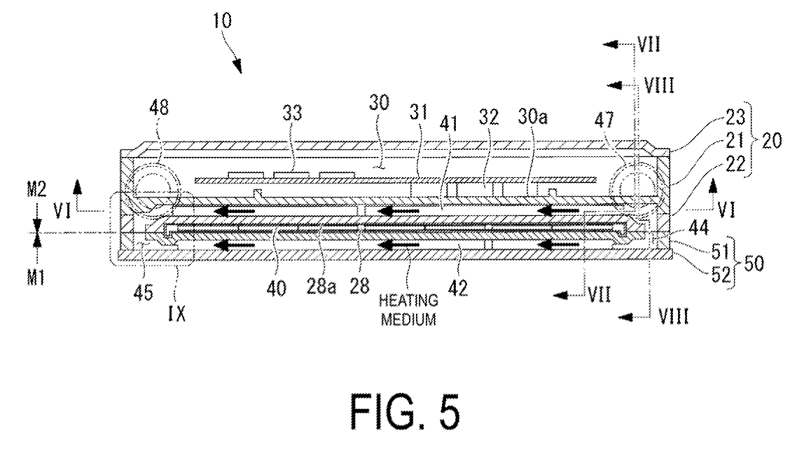

FIG. 2 is a perspective view of a heating medium heating device 10, FIG. 3 is a front view of a heating medium heating device 10, FIG. 4 is a plan view of heating medium heating device 10 seen from the direction indicated by the arrows IV-IV in FIG. 3, and FIG. 5 is a vertical cross-sectional view of the heating medium heating device 10 taken along the line V-V in FIG. 4. Note that in the descriptions given below, the directions X, Y, and Z illustrated in FIG. 2 are defined respectively as the “longitudinal direction,” the “transverse direction,” and the “thickness direction” of the heating medium heating device 10.

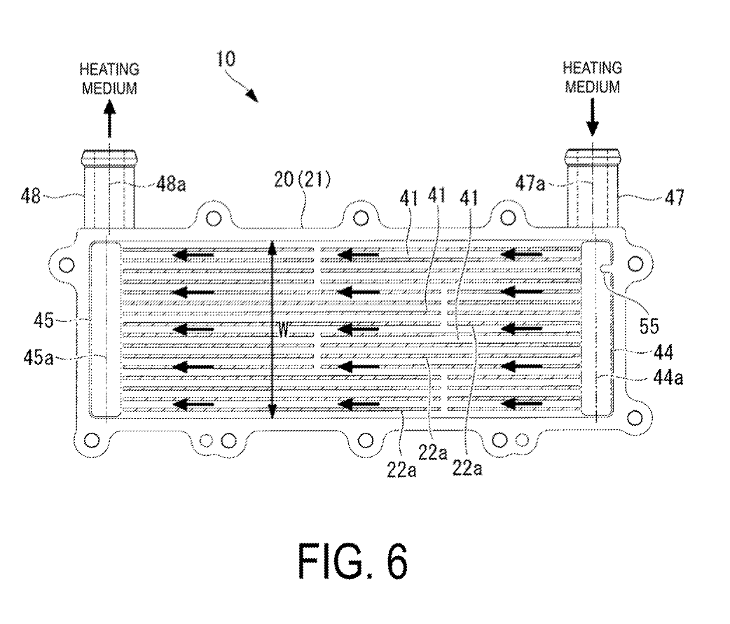

As illustrated in FIG. 2 to FIG. 5 and also in FIG. 6 to FIG. 9, the heating medium heating device 10 includes: a first heating medium distribution box 20 formed in a case shape by stacking, for example, three box-forming members 21, 22, and 23, one upon another; a second heating medium distribution box 50 formed in a case shape by stacking two box-forming members 51 and 52, one upon the other, and joined liquid-tightly to the bottom surface of the first heating medium distribution box 20; and a PTC heater 40 disposed between the first and the second heating medium distribution boxes 20 and 50.

The first heating medium distribution box 20 has a configuration where the upper heating medium distribution box 22 having a rectangular shape in plan view is joined liquid-tightly to the bottom surface of the electronic component accommodating box 21 having a rectangular shape as well, and where an upper cover member 23 is liquid-tightly fitted to cover the upper surface of the electronic component accommodating box 21. In addition, the second heating medium distribution box 50 has a configuration where the lower cover member 52 is liquid-tightly fitted to cover the bottom surface of the lower heating medium distribution box 51, which like the upper heating medium distribution box 22, has a rectangular shape. These members (21, 22, 23, 51, and 52) are made from a heat conductive material such as an aluminum alloy.

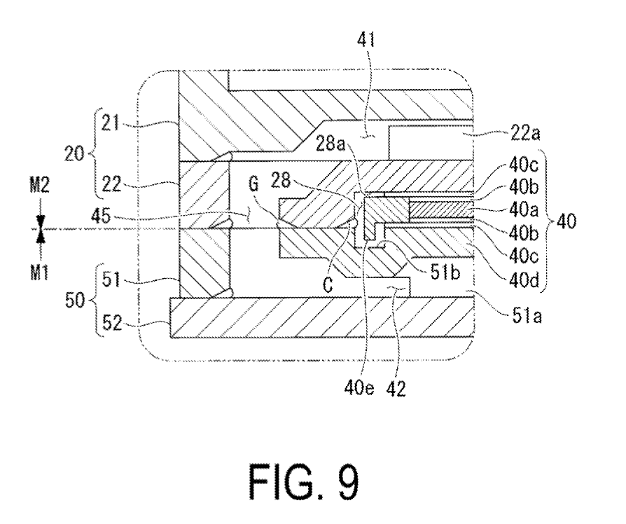

As illustrated in FIG. 2, the upper cover member 23 is fastened to the upper surface of the electronic component accommodating box 21 with a plurality of fixing bolts 25. The upper heating medium distribution box 22, the lower heating medium distribution box 51, and the lower cover member 52 are fastened to the bottom surface of the electronic component accommodating box 21 with a plurality of fixing bolts 26. Hence, the box-forming members 21, 22, 23, 51, and 52 are integrated into a single body. A liquid gasket G (see FIG. 9) is applied to seal the matching surfaces of the box-forming members 21, 22, 23, 51, and 52.

Note that, in the following description, as illustrated in FIG. 3, FIG. 5, and FIG. 9, the bottom surface of the first heating medium distribution box 20 (the bottom surface of the upper heating medium distribution box 22) will be referred to as the “first matching surface M1,” and the upper surface of the second heating medium distribution box 50 (the upper surface of the lower heating medium distribution box 51) will be referred to as the second matching surface M2.

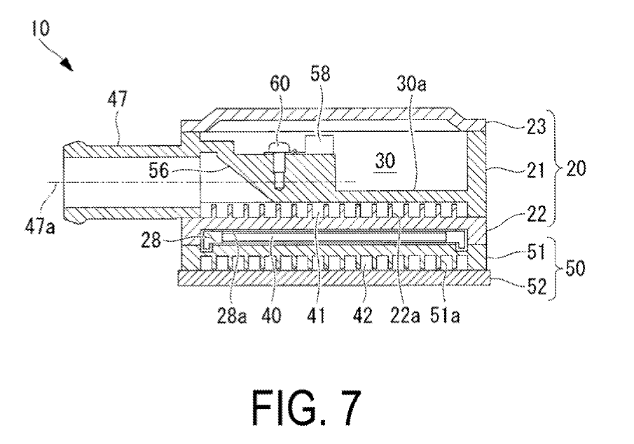

The PTC heater 40 has a flat, rectangular shape that is smaller than the rectangular shape of the upper heating medium distribution box 22 and the rectangular shape of the lower heating medium distribution box 51. As illustrated in FIG. 5, FIG. 7, and FIG. 9, a PTC heater accommodating chamber 28 is formed by making the flat second matching surface M2, i.e., the upper surface of the lower heating medium distribution box 51, seal liquid-tightly, via a liquid gasket G, a tray-shaped PTC heater accommodating recess 28a formed in the first matching surface M1, i.e., the bottom surface of the upper heating medium distribution box 22. The PTC heater accommodating chamber 28 thus formed accommodates the PTC heater 40.

As illustrated in the enlarged view of FIG. 9, the PTC heater 40 has a configuration where a structure is formed by covering each of the two surfaces of the PTC element 40a with an electrode plate 40b made from a good electric conductor material such as aluminum, and covering the electrode plate 40b with a compressive heat transfer sheet 40c made of a silicone sheet or the like. In addition, a frame member 40d made of a resin is provided around the peripheral edge part of the above-described structure. The compressive heat transfer sheets 40c located individually on the upper-surface side and on the lower-surface side of the PTC heater 40 are in close contact, respectively, with the bottom surface (ceiling surface) of the PTC heater accommodating recess 28a and the second matching surface M2 of the lower heating medium distribution box 51 so that heat can be conducted between the individual sheets 40c and the corresponding surfaces.

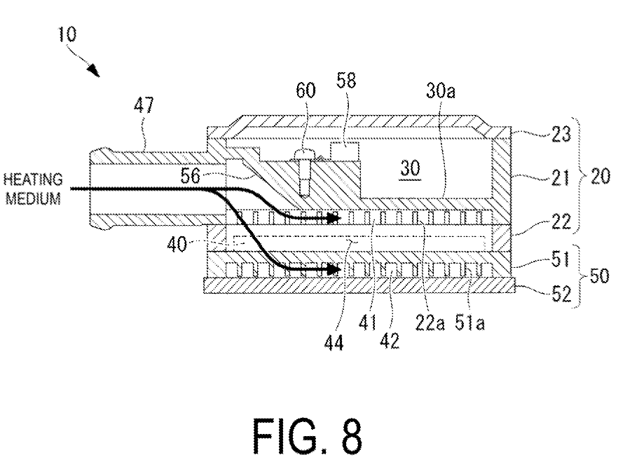

As illustrated in FIG. 5, FIG. 7, and FIG. 8, the inside of the electronic component accommodating box 21 serves as an electronic component accommodating chamber 30, where a control board (electronic component) 31 configured to control the PTC heater 40 is accommodated. The control board 31 incorporates components such as a heat generating electronic component 32 such as an insulated gate bipolar transistor (IGBT) and a field effect transistor (FET), other electronic components 33, a control circuit, and a power supply circuit.

The bottom surface of the electronic component accommodating box 21 (electronic component accommodating chamber 30) serves as a flat, electronic component cooling wall 30a. As illustrated in FIG. 5, the control board 31 is fixed, with an affixing structure (not illustrated), to a position that is higher than the electronic component cooling wall 30a. In addition, the heat-generating electronic component 32 is disposed on the bottom-surface side of the control board 31 and is in heat-transmissible contact with the electronic component cooling wall 30a. Note that an insulating layer (not illustrated) is provided between the electronic component 32 and the wall 30a. As illustrated in FIG. 2, a wire leading-out portion 35 is formed on a first-end surface of the electronic component accommodating box 21, and a wiring member 36 extending from the control board 31 is led out through the wire leading-out portion 35.

As illustrated in FIG. 5, FIG. 7, and FIG. 8, by making the flat upper surface of the upper heating medium distribution box 22 seal the tray-shaped recessed portion formed on the bottom surface of the electronic component accommodating box 21 included in the first heating medium distribution box 20, a first heating medium circulation path 41 is formed in the first heating medium distribution box 20. A plurality of heat radiation fins 22a are formed in the upper surface of the upper heating medium distribution box 22 along the longitudinal direction of the upper heating medium distribution box 22 (see FIG. 6 to FIG. 8). These heat radiation fins 22a divide the first heating medium circulation path 41 into a plurality of parallel flow paths.

In addition, by making the flat upper surface of the lower cover member 52 seal the tray-shaped recessed portion formed in the bottom surface of the lower heating medium distribution box 51 included in the second heating medium distribution box 50, a second heating medium circulation path 42 is formed in the second heating medium distribution box 50. A plurality of heat radiation fins 51a are formed on the bottom surface of the lower heating medium distribution box 51 along the longitudinal direction of the lower heating medium distribution box 51 (see FIG. 7 and FIG. 8). These heat radiation fins 51a divide the second heating medium circulation path 42 into a plurality of parallel flow paths.

As described earlier, the flat-shaped first heating medium circulation path 41 and the flat-shaped second heating medium circulation path 42 are formed so as to sandwich the similarly flat-shaped PTC heater 40. As illustrated in FIG. 5, FIG. 6, and FIG. 8, an inlet header space 44 is formed to secure the communication between the upstream ends of the first heating medium circulation path 41 and the second heating medium circulation path 42 whereas an outlet header space 45 is formed between the downstream ends of the first heating medium circulation path 41 and the second heating medium circulation path 42. As illustrated in FIG. 6 by the long dashed double-short dashed lines, these header spaces 44 and 45 are formed, in plan view, on the two end portions, in the longitudinal direction, of the heating medium heating device 10. Each of the header spaces 44 and 45 extends along the flow-path width direction (the transverse direction) of the first and the second heating medium circulation paths 41 and 42 over the entire range of the flow-path width W of the first and the second heating medium circulation paths 41 and 42.

In addition, an inlet portion 47 and an outlet portion 48 are formed respectively in the inlet header space 44 and the outlet header space 45. The inlet portion 47 and the outlet portion 48 allow the connection of the heating medium circulation circuit 11 (see FIG. 1) where the heating medium circulates. The inlet portion 47 and the outlet portion 48 have shapes allowing the coupling of hose members included in the heating medium circulation circuit 11. As illustrated in FIG. 2, FIG. 7, FIG. 8, and the like, the inlet portion 47 and the outlet portion 48 are formed integrally in the electronic component accommodating box 21, and are provided to overlap the thickness (height) range of the electronic component accommodating chamber 30 formed in the electronic component accommodating box 21 (see FIG. 5, FIG. 7, and FIG. 8).

As illustrated in FIG. 6, the inlet portion 47 and the outlet portion 48 are located so that in plan view, axial directions 47a and 48a of the inlet portion 47 and the outlet portion 48 are positioned substantially on the extension lines of axial directions 44a and 45a of the inlet header space 44 and the outlet header space 45. To put it another way, in plan view, the inlet portion 47 is linearly connected to the inlet header space 44 whereas the outlet portion 48 is linearly connected to the outlet header space 45. Note that a protruding portion 55 is formed on an inner surface of the inlet header space 44 at a position near the inlet portion 47. The protruding portion 55 changes the flow direction of some part of the heating medium having flowed in through the inlet portion 47, and then introduces that part of the heating medium to nearer side areas of the first and the second heating medium circulation path 41 and 42. The introduction increases the heat exchange efficiency.

As illustrated in FIG. 8, in side view, the inlet portion 47 is positioned so that the axial direction of the inlet portion 47 passes above the inlet header space 44. A slope portion 56, which is an inclined wall, is formed in the path of the inlet portion 47 at a position on the farther side of the inlet portion 47. The heating medium having flowed in through the inlet portion 47 hits the slope portion 56 and is made to change the flow direction downwards and thus flow into the inlet header space 44.

Though not illustrated, the outlet portion 48 is positioned so that the axial direction of the outlet portion 48 passes above the outlet header space 45, and a slope portion (not illustrated) is formed in the path of the outlet portion 48 at a position on the farther side of the outlet portion 48. The heating medium flows from the outlet header space 45 upwards, hits the slope portion, is made to change the flow direction and thus flow out of the outlet portion 48.

As illustrated in FIG. 4, FIG. 7, and FIG. 8, in the electronic component accommodating chamber 30, an inflow-temperature detecting sensor 58 and an outflow-temperature detecting sensor 59 are provided so that the sensors 58 and 59 are fixed to the inside of the chamber 30 with screws 60. The inflow-temperature detecting sensor 58 is configured to detect inflow-temperature of the heating medium flowing in the inlet header space 44, and the outflow-temperature detecting sensor 59 is configured to detect the outflow-temperature of the heating medium flowing in the outlet header space 45.

Next, a main part of the invention will be described below.

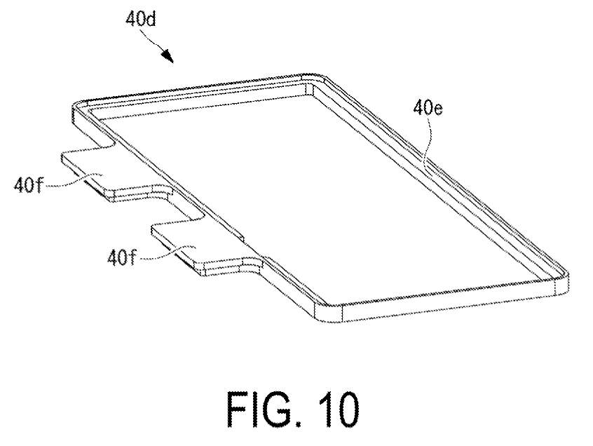

As illustrated in the enlarged view of FIG. 9, a barrier part 40e standing towards the second matching surface M2 of the upper heating medium distribution box 22 is formed on the frame member 40d, made of a resin, that forms the peripheral edge part of the PTC heater 40. The barrier part 40e, as illustrated also in FIG. 10, is formed by extending, towards the second matching surface M2, the outer peripheral surface portion of the frame member 40d formed in a frame shape, and is formed in a rising-wall shape that is contiguous in the circumferential direction of the frame member 40d. The barrier part 40e is integrally formed with the frame member 40d and is made from the same resin material (PBR, PPS, etc.) as the material of the frame member 40d. Note that terminal receiving plates 40f are integrally formed with the frame member 40d, and terminal portions (not illustrated) of PTC heater 40 are disposed in the terminal receiving plates 40f.

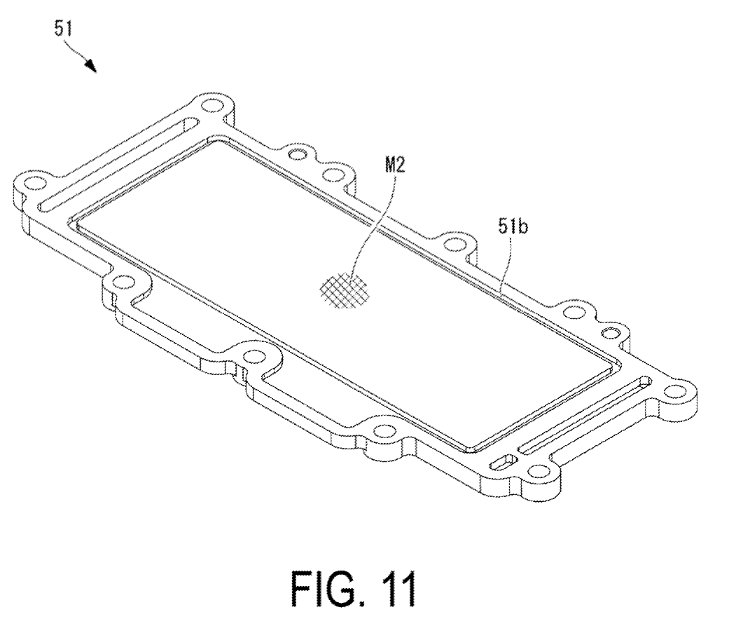

On the other hand, as illustrated in FIG. 9 and FIG. 11, a fitting groove 51b is formed in the second matching surface M2, so that the leading end of the barrier part 40e fits in the fitting groove 51b. In plan view, the fitting groove 51b has a geometrical shape that is similar to the barrier part 40e and the terminal receiving plates 40f of the frame member 40d. The fitting groove 51b is engraved in the second matching surface M2, i.e., the upper surface of the lower heating medium distribution box 51. The width and the depth of the fitting groove 51b are set so that neither any of the outer and the inner surfaces of the barrier part 40e nor the leading end of the barrier part 40e is in contact with the inner surface of the fitting groove 51b.

In addition, as illustrated in FIG. 9, a chamfered portion C is formed in the first matching surface M1 of the upper heating medium distribution box 22, specifically in the peripheral edge part surrounding the PTC heater accommodating recess 28a. The chamfered portion C may be formed in the second matching surface M2 of the lower heating medium distribution box 51, specifically in the outer peripheral edge part of the fitting groove 51b. By providing the chamfered portion C described above, the liquid gasket G applied to the interstice between the first matching surface M1 and the second matching surface M2 bulges into the chamfered portion C, but the liquid gasket G is less likely to protrude towards the PTC heater 40 in a great amount. Similar chamfered portions are also provided in the matching surfaces between the box-forming members 21 and 22 as well as between the box-forming members 51 and 52.

In the heating medium heating device 10 configured as described above, the heating medium flowing in the heating medium circulation circuit 11 illustrated in FIG. 1 flows in through the inlet portion 47 of the heating medium heating device 10 and is introduced into the inlet header space 44 as illustrated in FIG. 6 and FIG. 8. Then, the heating medium splits into the first heating medium circulation path 41 and the second heating medium circulation path 42. Each of the split flows of the heating medium in the first and the second paths 41 and 42 splits into multiple flows to pass through the flow paths formed between the heat radiation fins 22a and 51a of the heating medium circulation paths 41 and 42, respectively. Then, the split flows in these flow paths flow in the same direction (from the right-hand side to the left-hand side in FIG. 5 and FIG. 6).

Meanwhile, the heating medium is heated though the heat exchange with the PTC heater 40. The heating medium having passed through the first and the second heating medium circulation paths 41 and 42 as described above join together in the outlet header space 45. Then the joint flow of the heating medium flows out through the outlet portion 48 into the heater core 6 coupled to the downstream side of the heating medium heating device 10. The heat of the heated heating medium in the heater core 6 is provided for the purpose of heating the passenger compartment.

On the other hand, the heat-generating electronic component 32 mounted on the control board 31 in the electronic component accommodating chamber 30 of the electronic component accommodating box 21 and positioned to be in contact with electronic component cooling wall 30a exchanges heat via the electronic component cooling wall 30a with the heating medium flowing through the first heating medium circulation path 41, and thus the heat of the heat-generating electronic component 32 is taken away. Hence, the heating medium is heated by the PTC heater 40 and by the heat of the electronic components 32 as well.

As illustrated in FIG. 9, in the heating medium heating device 10 with this configuration, the barrier part 40e is provided to rise from the frame member 40d that forms the peripheral edge part of the PTC heater 40 towards the second matching surface M2 of the second heating medium distribution box 50 (lower heating medium distribution box 51).

Hence, even in the case where the liquid gasket G applied to the interstice between the first matching surface M1 and the second matching surface M2 bulges towards the PTC heater accommodating recess 28a, the bulging liquid gasket G is blocked by the barrier part 40e and thus does not interfere with the compressive heat transfer sheets 40c of the PTC heater 40.

In addition, the compressive heat transfer sheets 40c, on the other hand, would not become out of alignment in the surface direction to the extent that the compressive heat transfer sheets 40c would interfere with the liquid gasket G. Hence, the delay of the hardening of the liquid gasket G is prevented, resulting in an improved productivity of the heating medium heating device 10. In addition, by narrowing the gap between the liquid-gasket-coated portion within the matching surfaces and the periphery of the PTC heater 40, the heating medium heating device 10 is made more compact.

In addition, a fitting groove 51b that allows the leading end of the barrier part 40e to fit in is formed in the second matching surface M2. The fitting of the leading end of the barrier part 40e in the fitting groove 51b widens the distance between the compressive heat transfer sheets 40c of the PTC heater 40 and the liquid gasket G bulging from the interstice between the first and the second matching surfaces M1 and M2. Hence, the interference of the liquid gasket G with the compressive heat transfer sheets 40c is reliably prevented.

As the barrier part 40e is made from the same resin as the frame member 40d, the barrier part 40e is formed inexpensively, and the barrier part 40e interposed between the PTC heater 40 and the first and the second heating medium distribution boxes 20 and 50 made of a metal serves as an insulating member, and thus the occurrence of an electrical short circuit between the PTC heater 40 and the boxes 20 and 50 is prevented.

In addition, the barrier part 40e is formed integrally with the frame member 40d surrounding the periphery of the PTC heater 40. Thus, the barrier part 40e is provided without any significant increase in cost increase only by making a small change in the frame member 40d provided in the PTC heater 40 from the beginning. Note that as a modified example, it is conceivable that the barrier part 40e is formed in a band shape from cardboard or the like material and that a portion that is similar to the above-mentioned barrier part 40e may be formed by wrapping the band-shaped frame member 40d around the circumferential surface of the frame member 40d.

On the other hand, the chamfered portion C is formed in the first matching surface M1, specifically in the peripheral edge part surrounding the PTC heater accommodating recess 28a. Hence, even in the case where the liquid gasket G applied to the first and the second matching surfaces M1 and M2 bulges towards the PTC heater accommodating recess 28a, the bulging part is accumulated in the chamfered portion C before the bulging part bulges towards the PTC heater accommodating recess 28a.

Hence, the bulging amount of the liquid gasket G towards the PTC heater accommodating recess 28a is decreased, and thus the interference between the liquid gasket G and the compressive heat transfer sheets 40c is prevented.

In addition, the formation of the chamfered portion C allows a larger area of the liquid gasket G to contact with the air. Thus, a shorter hardening time of the liquid gasket G is achieved and thus a higher productivity of the heating medium heating device 10 is achieved.

As has been described thus far, according to the heating medium heating device 10 of this embodiment and according to the vehicle air conditioner using the heating medium heating device 10, the structure where the PTC heater accommodating chamber 28 is formed between the plurality of heating medium distribution boxes 20 and 50 and where the liquid gasket G is used to seal the interstice between the first and the second matching surface M1 and M2 suppresses the interference of the liquid gasket G with the compressive heat transfer sheets 40c layered individually on the two surfaces of the PTC heater 40.

Hence, the liquid gasket G is prevented from contacting the silicone compressive heat transfer sheets 40c and thus the hardening of the liquid gasket G is prevented from being delayed by such a contact. This enhances the productivity of the heating medium heating device 10. In addition, by narrowing, as much as possible, the gap between the periphery of the PTC heater 40 and the portion coated with the liquid gasket G within the matching surfaces M1 and M2, the heating medium heating device 10 is made to be a compact device in both the longitudinal and the transverse directions.

Note that the present invention is not limited only to the configuration of the above-described embodiment, and changes and modifications may be made as appropriate. Embodiments having such changes and modifications are included in the scope of claims of the present invention.

For example, the internal structure and/or layout of the heating medium heating device 10 according to the invention may be changed as long as such a change does not allow the heating medium heating device 10 to depart from the scope of the claims.

In addition, the configuration of the vehicle air conditioner 1 according to the invention does not have to be exactly the same as the one illustrated in FIG. 1. The component(s) and/or the layout may be changed appropriately as necessary.

### REFERENCE SIGNS LIST

1 Vehicle air conditioner
4 Blower
5 Cooler
6 Heater core
10 Heating medium heating device
20 First heating medium distribution box
28 PTC heater accommodating chamber
28a PTC heater accommodating recess
40 PTC heater
40a PTC element
40c Compressive heat transfer sheet
40d Frame member (peripheral edge part of PTC heater)
40e Barrier part
41 First heating medium circulation path
42 Second heating medium circulation path
50 Second heating medium distribution box
51b Fitting groove
C Chamfered portion
G Liquid gasket
M1 First matching surface
M2 Second matching surface

1. A heating medium heating device comprising:
a plate-shaped PTC heater formed by making compressive heat transfer sheets cover individually two surfaces of a PTC element;
a first heating medium distribution box including a first heating medium circulation path inside the first heating medium distribution box and a first matching surface in which a PTC heater accommodating recess is formed to accommodate the PTC heater, the PTC heater accommodating recess including a bottom surface with which the compressive heat transfer sheet located on a first-surface side of the PTC heater is in close contact;
a second heating medium distribution box including a second heating medium circulation path inside the second heating medium distribution box and a flat second matching surface that closes the PTC heater accommodating recess by being bonded, liquid-tightly via a liquid gasket, to the first matching surface, the second matching surface being a surface with which the compressive heat transfer sheet located on a second-surface side of the PTC heater is in close contact; and
a barrier part rising from a peripheral edge part of the PTC heater towards the second matching surface.

2. The heating medium heating device according to claim 1, further comprising a fitting groove formed in the second matching surface and allowing a leading end of the barrier part to fit in the fitting groove.

3. The heating medium heating device according to claim 1, wherein the barrier part is made from a resin.

4. The heating medium heating device according to claim 1, wherein the barrier part is formed integrally with a frame member surrounding the PTC heater.

5. The heating medium heating device according to claim 1, wherein a chamfered portion is formed in a peripheral edge part surrounding the PTC heater accommodating recess in the first matching surface.

6. A vehicle air conditioner comprising:
a blower configured to circulate any of outside air and air in the passenger compartment;
a cooler disposed on a downstream side of the blower; and
a heater core disposed on a downstream side of the cooler,
wherein a heating medium heated by a heating medium heating device according to claim 1 is allowed to circulate in the heater core.
